(19) United States
(12) Patent Application Publication
(10) Pub. No.: US 2026/0049932 A1
(43) Pub. Date: Feb. 19, 2026

(54) METHOD FOR THE RECONSTRUCTION OF A LOCATION-RELATED DECAY BEHAVIOR OF OPTICAL DATA

(71) Applicant: PicoQuant Innovations GmbH, Berlin (DE)

(72) Inventor: Max Tillmann, Berlin (DE)

(73) Assignee: PicoQuant Innovations GmbH, Berlin (DE)

(21) Appl. No.: 19/299,448

(22) Filed: Aug. 14, 2025

(30) Foreign Application Priority Data
Aug. 16, 2024 (DE) 1020241234954

(51) Int. Cl. G01N 21/64

(52) U.S. Cl. CPC G01N 21/6408; G01N 21/6458

(57) ABSTRACT

The invention relates to a method, an imaging system and a computer program for improved reconstruction of location-related decay behavior of microscopic sample distributions. For this purpose, a model function is proposed that models an image formation and is suitable for reconstructing a location-related decay behavior by fitting the model function to the captured data.

### CROSS REFERENCE TO RELATED APPLICATIONS

Benefit is claimed to Germany Patent Application No. 10 2024 123 495.4, filed Aug. 16, 2024, the contents of which are incorporated by reference herein in their entirety.

### FIELD

The invention relates to a method, in particular a computer-implemented method for reconstructing location-related temporal decay behavior of a sample distribution. Also described is a system and a computer program for carrying out the method according to the invention.

### BACKGROUND

In the field of optical microscopy in particular, sample distributions are captured using lens systems that enable optical imaging of the sample distribution, wherein the sample distribution is “smeared” during imaging with an optical spread function due to the laws of optics. This optical spread function is also referred to as the point spread function, PSF.

The aim of numerous microscopy methods is to determine and compensate for the influence of the spread function on the image, for example to produce a sharper image of the sample distribution.

In the prior art, various spatial deconvolution methods are used for this purpose, which deal with the aspect of reversing this non-uniquely reversible problem of smearing by the spread function.

While the field of deconvolution methods is well documented and described with regard to purely spatial intensity data of a sample distribution, the available methods are mostly inadequate, in particular in the field of microscopy methods that capture additional location-related properties of a sample distribution.

The invention focuses on sample distributions in which a location-related decay behavior of the sample distribution is also captured and is to be evaluated. Such data is often collected with so-called time-correlated single-photon counting (TCSPC) applications. However, other methods are also suitable.

Data on a sample distribution that exhibit a location-related decay behavior—for example in the form of determined photon arrival times—can be regarded as a 3-dimensional array, data(r, t), wherein each element of this array contains an intensity value. Here, r refers to the (in this example 2-dimensional) spatial coordinates and t refers to the temporal coordinate.

The aim of common evaluations is to determine the sample distribution including location-related decay behavior based on a distribution of model parameters, params_{i,j}, of a model function from the collected measurement data.

In the context of the present specification, the model parameters are also referred to as terms. The expression “parameter distribution” is aimed in particular at describing a spatial distribution of the values that the terms of the model function assume depending on the location.

The most widespread approach in the prior art considers the problem as a spatially separable problem, i.e. the determination of the model parameters params_{i,j} at a specific spatial coordinate r_{i,j}; is independent of the determination at all other spatial coordinates. This is referred to below as “pixel-by-pixel curve-fitting” or pixel-by-pixel evaluation.

In the case of an imaging system that is configured to collect data with sufficiently fine spatial sampling, i.e. the underlying PSF is larger than the sampling, this modeling is simplified in terms of image formation.

A point source in the object space with a certain set of parameters, for example an associated lifetime, is transferred in a spread manner into the image space by the imaging system according to its PSF. Spatial sampling means that a number of pixels in a certain spatial area in the image space must carry information about this one set of parameters. However, in data collected in this way, each of these pixels will have a reduced signal-to-noise ratio, SNR, compared to a coarser spatial sampling, as the available finite signal is distributed across the pixels.

A pixel-by-pixel estimation of the parameters, params_{i,j}, is strongly influenced by noise and other errors, which are caused, for example, by a specific optimization method at low SNR of the data.

If the SNR of the gathered data is so low that only a very unsatisfactory spatial distribution of the parameters can be reconstructed with a pixel-by-pixel analysis, “spatial binning” methods can be used. The SNR in the data that is combined/rebinned in this way increases at the expense of the spatial sampling. For spatially undersampled data, this also directly reduces the spatial resolution.

For initially spatially finely sampled data, the resulting spatial sampling usually falls below a critical value due to spatial binning, which severely limits or even prevents further image reconstruction methods such as spatial deconvolution. This also results in a loss of spatial resolution, which could theoretically be achieved with these image reconstruction methods without spatial binning.

In the field of fluorescence lifetime imaging, there are approaches in which the spatial distribution of only some parameters is estimated on spatially combined data. Both direct spatial rebinning and effective averaging over a certain spatial sampling area can be used here. Typically, this method is used to reconstruct location-related distributions, for example of the lifetime, spatial resolution of which is determined by precisely this rebinning and is generally reduced.

This location-related lifetime distribution is visualized here by superimposing intensity data calculated from a data representation with the original spatial sampling, with the aim of suggesting its higher visual resolution. However, this intensity data is also an estimate of the spatial distribution of parameters. In this approach, estimates of the spatial distribution of parameters based on different data sets are combined with each other without taking into account the spatial transformation (spatial averaging/rebinning) that connects these data sets with each other in the parameter estimation. This means that spatial parameter distributions determined in this way no longer optimally explain the measurement data.

In another approach, instead of spatially averaging the raw data prior to the pixel-by-pixel parameter estimation, the parameters are estimated pixel-by-pixel based on the original data and the spatial parameter distributions reconstructed in this way are then spatially averaged. It is also common practice in some cases to combine the spatial parameter distributions with each other in the averaging, i.e. to calculate an intensity-weighted average of the reconstructed spatial lifetime distribution, for example.

Depending on the model used for reconstruction, however, it is generally not clear how such an averaging should be parameterized “mathematically correctly” and can therefore also lead to scenarios in which the averaged spatial parameter distributions no longer optimally explain the measurement data. Regardless of the initial spatial sampling of the data, the spatial resolution of the spatial parameter distributions averaged in this way will in any case be reduced by the spatial averaging.

The aim of the invention is to better reconstruct the location-related decay behavior.

The problem according to the invention is solved by a method of the type mentioned at the beginning according to claim 1.

Advantageous embodiments of the invention are given in the dependent claims and are described below.

### SUMMARY

According to claim 1, a method, in particular a computer-implemented method, for reconstructing a location-related temporal decay behavior of a sample distribution extending along one or more spatial dimensions comprises the following steps:
Providing sample distribution data that has information about a location-related temporal decay behavior of the sample distribution and information about the spatial dimension(s) of the sample distribution,
Fitting a model function to the data to reconstruct the location-related decay behavior of the sample distribution, wherein the model function comprises adjustable location-dependent and time-dependent terms and at least one convolution with at least one of the location-dependent terms and a model of at least one spatial spread function, wherein the location-dependent and time-dependent terms are configured to model the location-related decay behavior of the sample distribution,
Outputting a result of fitting the model function, wherein the result comprises information about the location-related decay behavior of the sample distribution reconstructed by the fitting.

The model function designed according to the invention causes a fitting of the model function to the data, so that the location-related decay behavior is reconstructed in the course of the fitting.

In particular, this makes it possible to image two typically physically associated properties of the sample distribution accordingly in the model function, so that an improved reconstruction of the sample distribution and the location-related decay behavior is achieved.

The associated physical properties relate in particular to a location and a decay behavior, associated with the location, of the sample distribution, wherein this location is smeared by the spread function as a result of the imaging process, and thus the location-related decay behavior is also distributed accordingly.

In the context of the present specification, the expression “providing data” refers in particular to capturing the data on an evaluation unit that is configured to process the data further. Capturing can also refer to the retrieval of data from a data memory.

The data can be generated by means of an optical recording of the sample distribution and fed to the evaluation unit. Data from a simulated sample distribution can also be provided.

The data can therefore be provided in particular by a storage unit. The data can then be further processed by an evaluation unit.

Measured data typically comes from an imaging microscopic system that is designed to record the location-related decay behavior of the sample distribution.

In the context of the specification, the expression “sample distribution” refers in particular to a spatial arrangement of a plurality of sample elements, in particular wherein the sample elements each have at least one temporal decay behavior.

In the context of the present specification, the expression “location-related decay behavior” refers to, for example, a location-related temporal dynamic that can be observed with respect to the sample distribution, in particular a decay of an intensity of an optical radiation emitted by the sample distribution, in particular after an amount of energy supplied to the sample distribution, such as by an optical excitation pulse.

In the case of time-resolved fluorescence measurements, the decay behavior is measured in particular via time-resolved capture of fluorescence photons in response to an excitation light pulse, e.g. as part of a TCSPC procedure. In particular, capturing a duration between the excitation pulse and the detection of the fluorescence photons is decisive for capturing a location-related decay behavior. Other technologies for the capture of time-resolved fluorescence or phosphorescence via pulsed or modulated excitation and demodulated detection (frequency domain FLIM) are also common realizations.

The expression “location-related” refers in particular to a distribution of the decay behavior that can, but does not have to, vary spatially.

The sample elements can be individual entities, such as molecules, biomolecules, atoms, and/or nanocrystals, such as quantum dots. The sample elements can also be connected to each other by an interaction or interplay and therefore not have an independent decay behavior from each other.

The information about the spatial arrangement of the sample distribution and the location-related decay behavior can be implemented in the form of a multi-dimensional data array. The data array can have a dimension for each spatial dimension of the sample distribution and also a dimension that comprises the location-related decay behavior. The spatial dimensions can be quantized in pixels.

The model function is configured to model the sample distribution with regard to the spatial arrangement and the decay behavior.

The adjustable location-dependent and time-dependent terms and, in particular, the model of the spread function can be used to fit the model function to the data by means of a fitting method.

For this purpose, various parameters and terms can be varied so that the model function is as similar as possible to the data, i.e. any deviation between the data and the model function is minimized. The deviation can comprise a distance metric between the data and the model function and/or other terms that take into account, for example, noise statistics of the data. This similarity can be quantified by means of an error value, which can be determined from the sum of all deviations of the model function with the data. The person skilled in the art is familiar with corresponding fitting methods.

In particular, the model function comprises at least one time-dependent term in each case and at least one location-dependent term in each case.

In particular, the model function comprises one or more terms that describe a sample distribution before a convolution with the model of the spatial spread function. The fitted model function therefore also comprises terms that describe a reconstructed sample distribution.

It is provided that the location-dependent and time-dependent terms are comprised in an, in particular in exactly one, model function, and the model function is fitted to the data by fitting all the terms, and in particular not by fitting only selected terms, for example only location-dependent or only time-dependent terms.

For the first time, the invention provides reflecting a fitting of all location-dependent and time-dependent terms in one model function, so that, in particular during fitting, no factorization with respect to spatial and non-spatial dimensions takes place.

The fitting can be done by convolution of a reconstructed sample distribution and of an associated location-related decay behavior with the model of one or more spread functions.

According to a further embodiment of the invention, the model function comprises several convolutions, in particular spatial convolutions.

The model of the spread function can comprise a plurality of spread functions or parts of the spread functions that originate, for example, from different spaced planes of three-dimensional spread functions.

A spread function within the meaning of the invention is in particular any function or association that does not convert a delta function back into a delta function.

In particular, a delta function is not regarded as a spread function within the meaning of the invention.

The sample distribution data is captured or sampled, in particular with respect to a spread function on which a recording of the sample distribution is based, at least according to a spatial resolution which does not prematurely truncate the spatial frequencies of the spread function.

The invention makes it possible to determine noise-reduced reconstructions of the location-related decay behavior for data, wherein noise is reduced via a spatial reconvolution of the reconstructed sample distribution.

The method according to the invention can be practiced in a variety of applications. The reconstruction according to the invention of the location-related decay behavior can be used in the following applications:
In applications comprising spatial deconvolution in 2D and especially in 3D, wherein a location-related decay behavior of the 2D or 3D sample distribution is also captured and reconstructed by the fitting,
In applications that achieve so-called computational sectioning, such as in the evaluation of 2D multiview data, in which a location-related decay behavior of the sample distribution is also captured, e.g. in connection with
structured illumination microscopy, e.g. in JostA, Tolstik E, Feldmann P, Wicker K, Sentenac A, Heintzmann R (2015) Optical Sectioning and High Resolution in Single-Slice Structured Illumination Microscopy by Thick Slice Blind-SIM Reconstruction. PLoS ONE 10(7): e0132174. https://doi.org/10.1371/journal.pone.0132174,
image scanning microscopy, e.g. in Tortarolo, G., Zunino, A., Fersini, F. et al. Focus image scanning microscopy for sharp and gentle super-resolved microscopy. Nat Commun 13, 7723 (2022). https://doi.org/10.1038/s41467-022-35333-y or Gregor I, Enderlein J, Image Scanning Microscopy, Current Opinion in Chemical Biology, Current Opinion in Chemical Biology, Volume 51, 2019, Pages 74-83, ISSN 1367-5931, https://doi.org/10.1016/j.cbpa.2019.05.011,
split-PIN, e.g. in Di Franco, E., Costantino, A., Cerutti, E. et al. SPLIT—PIN software enabling confocal and super-resolution imaging with a virtually closed pinhole. Sci Rep 13, 2741 (2023). https://doi.org/10.1038/s41598-023-29951-9
   gated-STED reconstructions
   spectral FLIM.

In relation to the prior art, it is particularly novel that the reconstruction of the non-spatial parameter distributions, i.e. the location-related decay behavior, simulates the image formation and the model function is designed accordingly.

A suitable, possibly complex regularization of the parameter distributions as part of the fitting can be advantageous.

Advantageously, the method can be carried out on a plurality of GPUs. Various computer-based, including decentralized, solutions are collectively referred to as “computer-implemented” in the context of the specification. The expression computer in the context of the present specification comprises in particular a plurality of GPUs and/or other, in particular clustered, computing units.

Furthermore, suitable memory-efficient optimization routines can advantageously be selected (e.g. L-BFGS).

A suitable compression of the data of the non-spatial dimension is particularly advantageous, which is represented in various embodiments of the specification below.

Even with current-generation GPUs and data compression, the data volumes are large, such that a data division into tiles with overlap and subsequent reassembly (tiling and stitching) can be advantageous, especially for spatial 3-dimensional reconstructions and/or reconstructions that combine several data sets with each other.

In an advantageous realization of the invention, complementary data sets can also be reconstructed together. Such “joint reconstructions” can generate very advantageous reconstructions, e.g. portions of information originating from different focal planes can be separated on the basis of spatial 2-dimensional measurement data (in particular focus-ISM, optical sectioning SIM).

The invention generalizes existing approaches, which are shown only for intensity data, to such advantageous reconstructions of parameter distributions whose information is encoded in non-spatial dimensions, here at least in the location-related decay behavior of the sample distribution.

According to a further embodiment of the invention, one or more time-dependent terms comprise one or more decay terms which are configured to model the location-related decay behavior of the sample distribution and/or properties of a detector related thereto, e.g. a temporal response function of the detector.

According to a further embodiment of the invention, the model function comprises one or more mixed terms that are both time-dependent and location-dependent.

This embodiment is advantageous for displaying imaging in an optical microscopy method in the model function. In the prior art, fitting such a complex model function is avoided and instead model functions that can be separated with respect to the location-dependent and time-dependent terms are sought.

According to a further embodiment of the invention, at least one mixed term is convolved with the model of the at least one spatial spread function.

This variant of the invention also serves to improve the capture of a physical principle underlying the recording or else image formation.

According to a further embodiment of the invention, when fitting the model function, the terms, i.e. the location-dependent, the time-dependent and/or also the mixed terms, are fitted in such a way that an error function is minimized.

In particular, the error function is configured to output an error value that is indicative of a deviation of the model function from the data.

In particular, the error function is fitted to a noise statistic of the data, so that the error function models deviations due to the noise of the data.

According to a further embodiment of the invention, the error function contains one or more regularization terms which may be designed to prevent overfitting of the model function to the data.

The person skilled in the art is familiar with regularization terms in an error function, especially their use in solving inverse problems. Without these regularization terms, the model function could also be fitted to the noise of the data (i.e. an overfitting), which can lead to non-physical or else artifact-affected solutions.

To avoid overfitting, iterative fitting methods for fitting the model function to the data can be aborted after a certain number of fitting cycles. The number of cycles can depend on a change in an error value output by the error function. In the asymptotic limit, where the error value is no longer minimized, there would be an overfitting if the error function has no regularization terms. Even an error value that is, for example, 20% below the asymptotic limit, in particular 10% or 5% below the asymptotic limit, can result in an overfitting in the absence of regularization terms. The exact value is strongly determined by the SNR of the data to be reconstructed.

According to a further embodiment of the invention, the reconstructed sample distribution, in particular the terms of the model function which model the location-related decay behavior, is convolved with the fitted model of the at least one spatial spread function, so that a noise-reduced reconstruction of the location-related decay behavior of the sample distribution is generated, in particular wherein this noise-reduced reconstruction is output at least as part of the result.

This embodiment is particularly advantageous compared to the prior art. The reconstructed sample distribution does not necessarily have to represent a physically meaningful sample distribution. This embodiment does not aim to generate a representation of the sample distribution with increased spatial resolution, but primarily attempts to generate a noise-reduced image of the location-related decay behavior.

In the limiting case, e.g. when the model function is overfitted to the data, the reconstructed sample distribution comprises many point-like elements, which are commonly regarded as artifacts. However, a convolution of this reconstructed sample distribution, i.e. in particular of the location-dependent and time-dependent terms, with the model of the spread function results in a noise-reduced reconstruction of the location-related decay behavior, which is free of these artifacts and which cannot be generated with any other prior art method.

It should be noted that the fitting of the model function does not necessarily have to take place as part of an overfitting. A moderate loss of resolution can be accepted in this embodiment in favor of a noise-reduced representation of the decay behavior.

According to a further embodiment of the invention, the data comprises information about a further property of the sample distribution, in particular information about a location-related fluorescence spectrum of the sample distribution, wherein the model function comprises further adjustable terms which model this property. These terms can be wavelength-dependent terms, which are also fitted when fitting the model function to the data. In particular, these further terms are also convolved with the model of the spread function.

This embodiment makes it possible to evaluate higher dimensional data, such as spectral FLIM data, in the same advantageous way according to the invention.

According to a further embodiment of the invention, the data of the sample distribution along dimensions which contain information about a temporal decay behavior and/or further properties of the sample distribution are compressed with respect to the temporal decay behavior and in particular the further properties.

This embodiment makes it possible to reduce the amount of data in an advantageous way.

Preferably, the data relating to the location-related decay behavior can have a histogrammed representation of the decay behavior, each of which has non-equidistant bins, in particular wherein the width of the bins is implemented by an information content of the histogrammed representation, wherein, the lower an associated histogram value of the histogrammed representation is, the greater the width of the bins can be.

This type of compression of the data with regard to decay behavior offers great potential for reducing data volumes, while the loss of information, in contrast, is low and, in particular, uniform.

According to a further embodiment of the invention, the model function comprises a plurality of predefined patterns, wherein each pattern is associated a term from the model function or is comprised by a term which is configured to cause a weighting, in particular a location-dependent weighting, of the pattern in the model function.

The expression “pattern” in the context of the present specification is used in particular for one or more terms of the model function which, for example, have a predetermined shape along one or more dimension(s) of the data, which shape can only be fitted by scaling along the dimension(s) and/or in a weighting.

A pattern can comprise, for example, a decay behavior, wherein a weighting of the pattern in the model function is determined in each case based on the location.

According to a further embodiment of the invention, each pattern of the plurality of patterns is selected from the group consisting of:
a decay behavior;
a spatial spread function;
a spectrum, time-resolved or steady-state;
an out-of-focus signal;
an in-focus signal;
a combination of the above group elements.

In particular, at least one pattern comprises a decay behavior.

In particular, it is advantageous to associate the out-of-focus signal with one pattern and the in-focus signal with another pattern. This combination allows so-called “sectioning” of the data and thus an improved representation of the sample distribution, which is cleaned of out-of-focus contributions.

The expression “in-focus signal” refers in particular to a signal portion of the optical signal captured from the sample distribution which originates from one or more focal planes, while in contrast the “out-of-focus signal” refers in particular to a signal portion of the optical signal captured from the sample distribution which does not originate from one or more focal planes.

A pattern comprising a decay behavior can comprise the response function of the detectors as well as a decay behavior modeled in any way, which is particularly advantageous if individual decay components of the decay behavior are known (for example, by upstream measurements) and only different portions of these components are to be determined.

The following embodiments are of particular interest with regard to applications that involve data sectioning:

According to a further embodiment of the invention, two or more recordings of the sample distribution are provided, wherein the model comprises two or more different spread functions, wherein the model comprises, for each of the two or more spread functions, at least one in-focus and one out-of-focus distribution of the respective spread function in each case, wherein an in-focus signal of the sample distribution is modeled on the basis of the in-focus and out-of-focus distributions and a signal of the sample distribution which lies outside a focal plane is modeled, and, by means of the fitting of the model function, a representation of the sample distribution which lies in focus and in particular has no or only a few portions of out-of-focus portions is generated.

This embodiment can be used both on confocal systems with point or linear excitation and detection, or in wide-field microscopes with suitably structured illumination.

In a confocal microscope, a first spread function can be defined, for example, by confocal detection of the signal via a first pinhole, and a second spread function can be defined by confocal detection of the signal via a second pinhole or a second aperture with a different diameter. The second aperture can be given by the detector surface and thus be significantly larger or smaller than, for example, the first pinhole.

A distribution is known in each case for the first and second spread functions—the in-focus distribution—which represents a part of the (3D) spread function in the focal plane, i.e. a section through the spread function in the focal plane.

This distribution can be measured or modeled, for example.

In addition, at least one further distribution is known for both spread functions—the out-of-focus distribution—which corresponds to a section through the spread functions above and/or below the focal plane.

The method now makes it possible to use the model function to determine both a location-related decay behavior that corresponds to a signal from the focal plane, and optionally also a location-related decay behavior that is associated to a signal outside the focal plane.

By representing the location-related decay behavior associated to the focal plane, an improved reconstruction of the sample distribution in the focal plane can be achieved.

This embodiment allows the reconstruction of greatly improved location-related decay behavior of a sample distribution, which has not been achieved to date in the prior art.

The invention also makes it possible to separate data from wide-field recordings with suitably structured illumination into in-focus and out-of-focus portions with regard to the decay behavior, thus enabling advantageous sectioning, for example for lifetime measurements with wide-field systems. For this purpose, such wide-field systems have, for example, detectors that can capture the sample signal in a time-resolved and, in particular, time-correlated manner.

In particular, the two or more recordings of the sample distribution can also be two or more recordings at an axial distance, which is selected in such a way that both recordings contain, in part, in particular in large part, information about the same section of the three-dimensional sample distribution, which, however, is imaged with other portions of the three-dimensional spread function in the respective recordings. In comparison to a spatially three-dimensional reconstruction, the aim here is not to reconstruct a spatially three-dimensional sample distribution of high quality, but to separate the in-focus portions of the sample distribution, which lie in the axial planes of the respective recordings, from the out-of-focus portions, which originate from axially offset planes. In particular, the axial distances between the recordings are therefore selected to be larger than for data that is typically used for three-dimensional reconstructions of high quality.

According to a further embodiment of the invention, one spread function of the two or more spread functions comprises an excitation pattern (structured illumination), and another spread function of the two or more spread functions comprises a detection spread function.

This embodiment allows sectioning of decay behavior in the aforementioned wide-field system. For this purpose, the excitation of the sample distribution should take place with one or more excitation patterns and an associated recording should be created in each case.

The detection spread function corresponds to the spread function on the detector side.

According to a further aspect of the invention, an optical imaging system, in particular an optical microscope system, is disclosed, wherein the system comprises a microscope and a computer which is configured to control the system and to receive the data recorded by the microscope and process it according to the method according to the invention.

According to a further aspect of the invention, there is disclosed a computer program comprising computer program code which, when executed on a computer, performs the method according to the invention.

The computer can be, for example, the computer of the system.

According to a further embodiment of the invention, a plurality of recordings of the sample distribution is generated by an image-scanning microscopy method, wherein the model function comprises a plurality of models of a spread function, wherein the models each capture an optical offset of the plurality of recordings from each other, wherein a resolution-enhanced location-related decay behavior of the sample distribution is determined by incorporating the image-scanning microscopy method.

According to a further embodiment of the invention, the result comprises further information, wherein the information is selected from the group comprising one or more of the following elements:
the fitted model function,
one, several or all fitted terms,
or the determination of specific frequency portions of the temporal decay behavior in the form of a phasor.

The method according to the invention can be applied to super-resolution microscopy methods that capture a decay behavior of the sample distribution, such as FLIM-STED (Fluorescence Lifetime Imaging Stimulated Emission Depletion).

In the following, various exemplary model functions are disclosed with which the method according to the invention can be advantageously implemented.

### BRIEF DESCRIPTION OF THE DRAWINGS

Further features and advantages of the invention are explained below with reference to the following description of figures of exemplary embodiments. In the figures:

FIG. 1 shows a decay behavior at one location of a sample distribution;

FIG. 2 shows a diagram of a sample distribution and the data of the sample distribution;

FIG. 3 shows results of the method according to the invention compared to the prior art;

FIG. 4 shows reconstruction of the location-related decay behavior of a sample distribution over reference decays including sectioning using the example of multi-view data;

FIG. 5 shows reconstruction of the location-related decay behavior of a sample distribution over reference decays including sectioning using the example of wide-field data with structured excitation; and

FIG. 6 shows reconstruction of a low-noise location-related decay behavior.

### DETAILED DESCRIPTION

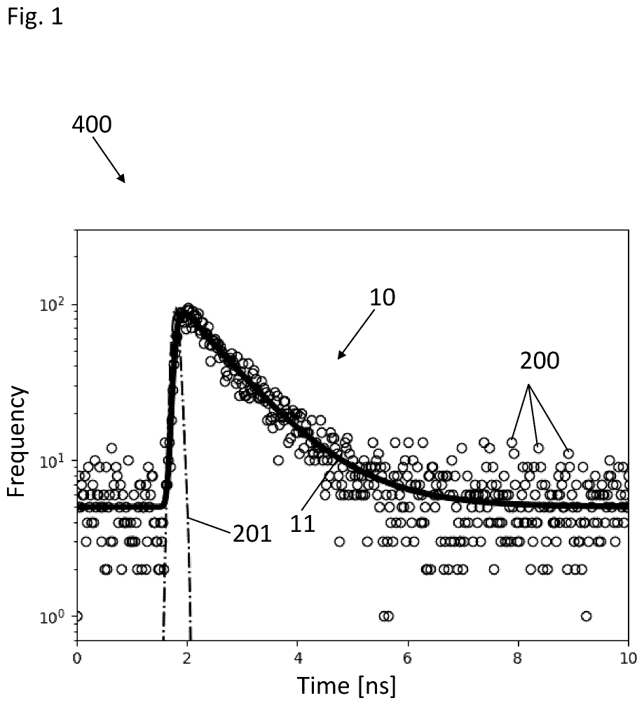

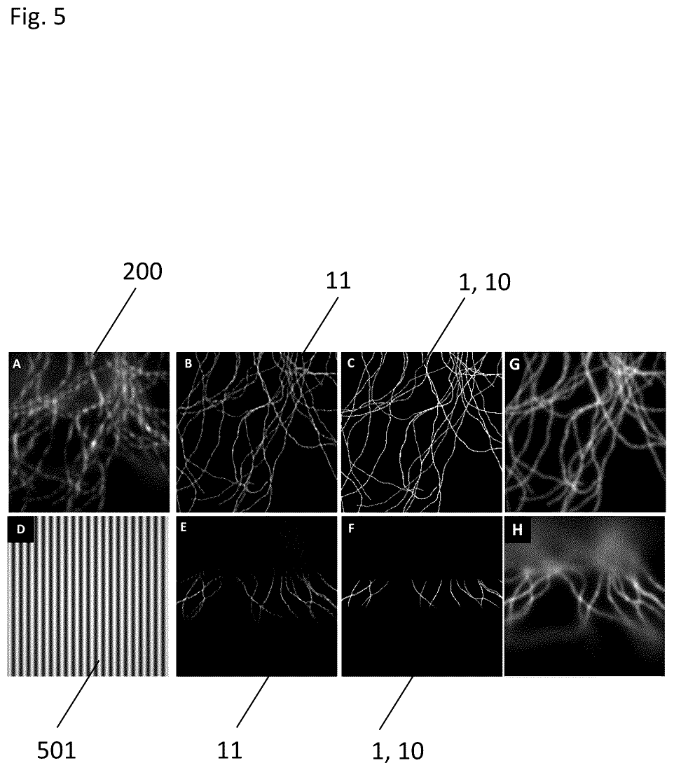

FIG. 1 represents data 200 (represented as circles) of a decay behavior 10 of a sample distribution 1 (see e.g. FIG. 5, panel C) at one location. The data was recorded using a time-correlated single-photon counting (TCSPC) method.

The data is available in the form of a histogram 400 with an identical bin width along the x-axis. Alternatively and as described, the bin width can also be selected in different sizes in order to compress the data (not represented). The expression “bin width” refers here in particular to a time span that is combined in a bin. The histogram 400 is represented logarithmically along the y-axis (frequency axis) to better visualize the exponential decay behavior typically observable in fluorescence decays.

The data 200 has a pronounced shot noise, which comes to the fore at low photon counts.

When fitting the data 200, for example, a model of the decay behavior is used that has both a characteristic of the system response function (temporal IRF, 201) and decay-describing, for example exponential, decay functions, as described in the previous equations.

The fitted terms are then convolved again accordingly with the models of the IRF and, if necessary, with the model of the spread function in order to generate the reconstructed fitted decay curve 11.

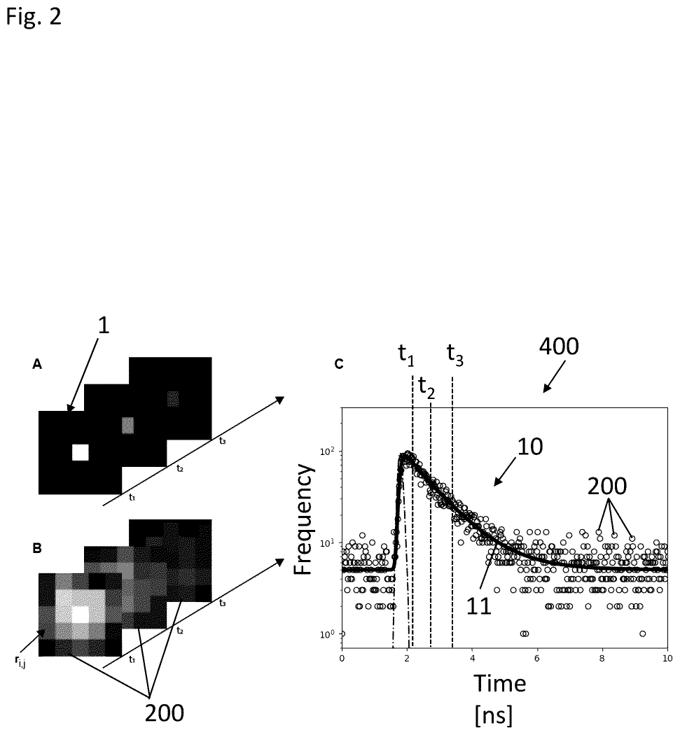

The underlying problem with sample distributions whose decay behavior is to be reconstructed is represented in FIG. 2.

In FIG. 2, panel A represents a time-resolved series of the location-related decay behavior 10 of the sample distribution 1 for three points in time t₁, t₂, t₃ in space for a point-shaped sample distribution 1.

Panel B represents exemplary data 200 that can be captured from such a signal. The data 200 comprises information relating to two spatial dimensions as well as information about the location-related decay behavior 10 of the sample distribution 1. The signal relating to the spatial distribution is smeared with a spread function due to the actual or simulated optical capture, for example with an optical microscope, i.e. the photons emitted by the sample distribution 1 are distributed over a range of the spread function in space according to the shape of the spread function at the locations r_{i,j}.

As an example, the dynamics of the decay behavior for a location r_{i,j} is represented in higher time resolution in panel C (see also FIG. 1) together with the three points in time (vertical lines).

This means that in addition to the spatial information about the sample distribution, the information regarding the decay behavior 10 is also spatially spread, which is disadvantageous with regard to the photon statistics.

In the prior art, to reconstruct the decay behavior, the decay behavior is often adjusted separately for each captured spatial point, e.g. for each pixel, of the sample distribution, without including information about the decay behavior of neighboring spatial areas. In the present case, a spatial summary of the captured data appears to make sense, but only because the sample distribution is point-shaped. Typically, one does not know the actual sample distribution (panel A), and therefore such a simplifying measure of combining would be at least problematic and would lead to artifacts or a loss of spatial resolution of the sample distribution.

Therefore, in the prior art, the decay behavior is determined individually for each captured spatial point, e.g. pixel, which has considerable disadvantages due to the reduced photon statistics.

The invention provides for taking into account the spreading influence of the spread function when reconstructing the location-related decay behavior, so that the reconstruction does not have to be carried out pixel by pixel and thus benefits from better photon statistics.

The approach of reconstructing the location-related decay behavior in relation to an underlying sample distribution (panel A), which is convolved with a spread function, using a model function also represents an approach which is physically correct compared to other reconstruction methods for location-related decay behavior.

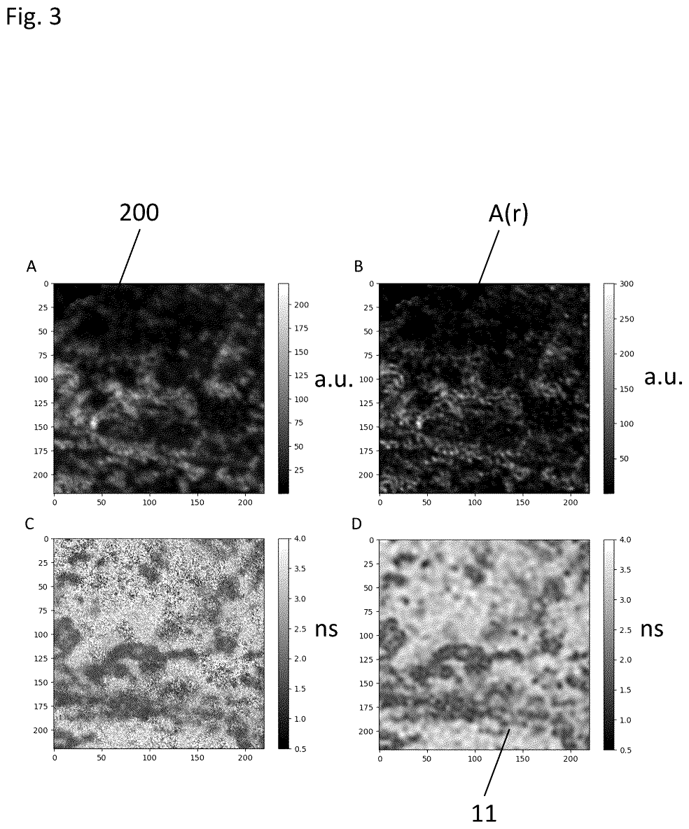

FIG. 3 represents an example of the difference between the methods applied in the prior art and the method according to the invention using a data set.

In this example, the data, data(r, t), is available as a three-dimensional array with two spatial dimensions and a photon arrival time dimension that comprises the location-related decay behavior.

The x- and y-axes of the representations correspond to the location and are represented in units of pixels. A conversion to metric positions and distances is known to the person skilled in the art, provided that various system parameters are determined.

The gray scales in FIG. 3, panels A and B, correspond to an intensity in arbitrary units. The gray coding can be taken from the adjacent gray value scales.

The gray scales in FIGS. 3, panels C and D, correspond to a determined decay time in nanoseconds.

FIG. 3, panel A shows an intensity projection of the raw data Σₜ data(r, t) that does not comprise any information about the decay behavior.

FIG. 3, panel C shows a pixel-by-pixel determination of the location-related decay behavior 10, in which the information regarding the decay behavior 10 is evaluated individually and independently in each pixel.

FIG. 3, panel B shows a reconstruction of the intensity distribution before the influence of the spreading effect of a spread function I_{recon}(r)∝A(r) according to the invention.

FIG. 3, panel D shows a reconstruction of the location-related decay behavior 11 and in particular of the lifetimes T_{recon}(r) before the influence of the spreading effect of a spread function according to the invention.

When comparing FIG. 3, panel C and 3, panel D, a clear improvement and reduced noise of the reconstructed location-related decay behavior 11 can be seen in FIG. 3, panel D. This is achieved by improved modeling of the location-related decay behavior 10. After the model function has been fitted to the data 200, individual fitted terms, such as the reconstructed location-related decay behavior T_{recon}(r) 11, can be output as a result, as occurs in FIG. 3, panel D. Other fitted terms, such as the amplitude A(r) of the decay behavior, can also be represented separately and in an improved manner (FIG. 3, panel B).

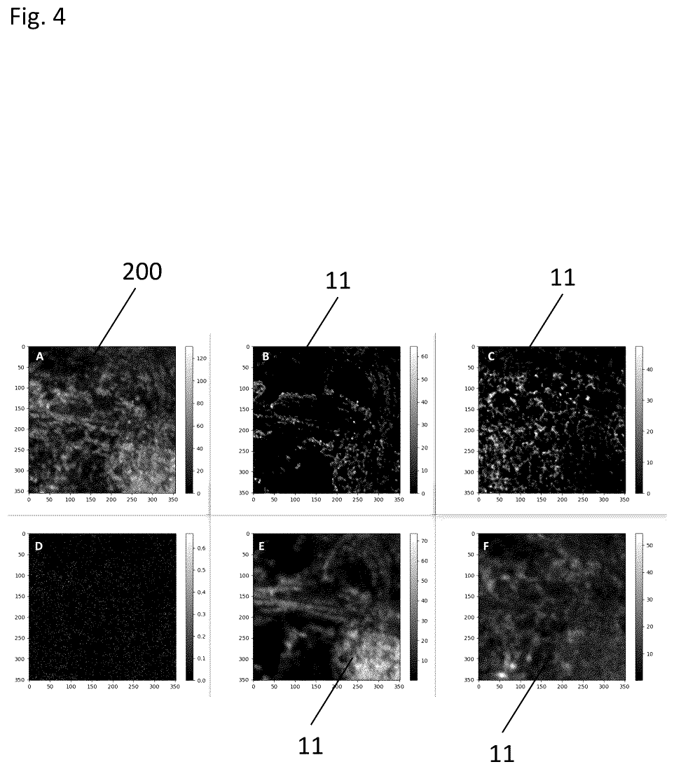

A further illustrative embodiment of the method is represented by way of example in FIG. 4.

The data 200 comprises spatially two-dimensional location information, with an additional photon arrival time dimension and an additional dimension with d=23 complementary perspectives—here using the example of image scanning microscopy lifetime data. The data set can be regarded as a 4-dimensional array data(r, t, d). As an example, “unmixing” of the data is shown in this example using p=2 reference decays, which use information of the photon arrival time dimension, and q=2 reference patterns, which use information of the d complementary perspectives. This means that the method comprises patterns—the decay patterns—which describe the p reference decays and further q patterns—the reference patterns—which serve to separate in-focus and out-of-focus signals.

When reconstructing the location-related decay behavior 10, each decay pattern can be associated with a location-related weighting, which can be regarded as the location-related intensity of the decay.

The decay patterns are associated with the spatially resolved decay behavior.

The x- and y-axes of the representations correspond to the location and are represented in units of pixels. A conversion to metric positions and distances is known to the person skilled in the art, provided that various system parameters are determined.

The gray scales in FIG. 4, panels A to F correspond to an intensity in arbitrary units. The gray coding can be taken from the adjacent gray value scales.

FIG. 4, panel A shows an intensity projection of the data Σ_{t,d} data(r, t, d).

FIG. 4, panel B shows a location-related intensity of a first decay pattern, of the two decay patterns and of a first reference pattern for information from the focal plane, which was determined using the method according to the invention.

The intensity of the first decay pattern corresponds, for example, to a location-dependent term of the model function.

The reference patterns are used to section the data.

These reference patterns can be determined directly from an ISM data set or else derived from the three-dimensional spread functions for d=23 the complementary perspectives.

FIG. 4, panel C shows a location-related intensity of a second decay pattern, of the two decay patterns and of a first reference pattern for information from the focal plane, which was determined using the method according to the invention.

The intensity of the second decay pattern corresponds, for example, to a location-dependent term of the model function.

FIG. 4, panel D shows a determined background of the data, which also corresponds to a location-dependent term, background, of the model function. The intensity of the background should be low compared to the intensity data in FIG. 4, panel B and FIG. 4, panel C.

For the sake of completeness, the results of the intensities of the first and second decay functions outside the focal plane are also represented in FIG. 4, panels E and 4F. FIG. 4 panels B, C, E and F can be understood as reconstructed, location-related decay behavior of the sample distribution. These illustrations each represent different aspects of this decay behavior.

A further advantageous embodiment of the invention is illustrated in FIG. 5.

This variant refers to the reconstruction of the spatially resolved decay behavior, whose associated data were recorded with a wide-field microscope with structured excitation. The data 200 comprises three time-resolved recordings of the sample distribution, wherein each of the recordings was created with a different excitation spread function. In this case, the excitation spread functions are periodic excitation patterns 501, which are aligned in different phase steps along the focal plane (see FIG. 5, panel D). Furthermore, the recordings each comprise a detection spread function, which can comprise the detector properties and sample properties.

At least one in-focus distribution and one out-of-focus distribution are known for each of the spread functions.

Furthermore, the reconstruction in this example provides that the model function, as explained in the previous example, describes the decay behavior 10 using two decay patterns, for each of which location-related intensities are determined.

Based on this information, it is then possible according to the invention to determine the location-related decay behavior 11 for this data according to the two decay components in and outside the focal plane.

This is particularly advantageous for applications in which camera-type detectors are used, which have a sufficiently high time resolution with which the decay behavior can be recorded. One example is so-called SPAD arrays.

The combination of such data with the method according to the invention makes it possible to reconstruct the location-related decay behavior in a particularly advantageous way.

The example thus shows data with an additional photon arrival time dimension and an additional dimension with d=3 complementary perspectives—here using the example of “structured illumination” microscopy data. The data set can be regarded as a 4-dimensional array data(r, t, d). In this example, “unmixing” of the data is achieved via p=2 reference decays, which use information of the photon arrival time dimension and the various spread functions described above.

FIG. 5, panel A shows an intensity projection data Σₜ data(r, t, d) for one of the d=3 excitation patterns. The periodicity of the excitation pattern is easy to recognize.

FIG. 5, panel B shows a location-related intensity of a first decay pattern, of the two decay patterns in the focal plane, which was determined using the method according to the invention.

The intensity of the first decay pattern corresponds, for example, to a location-dependent term of the model function.

Corresponding to this, the “ground truth” on which the recording is based is represented in FIG. 5, panel C with regard to the location-related decay behavior 10 of the first decay pattern. This is therefore simulated data.

FIG. 5, panel G shows the signal of the first decay that would be recorded at the detector without the sectioning approach if all recordings of the three excitation patterns were added together. This signal could not be observed separately in the presence of the second decay. The illustration merely serves to show how the location-related decay behavior of the first decay extends in the focal plane.

FIG. 5, panel E shows a location-related intensity of a second decay pattern, of the two decay patterns in the focal plane, which was determined using the method according to the invention.

The intensity of the second decay pattern corresponds, for example, to a location-dependent term of the model function.

Analogously, FIG. 5, panel F shows the ground truth for the sample distribution with respect to the second decay in the focal plane.

Analogously to FIG. 5, panel G, FIG. 5, panel H represents the signal of the second decay that would be recorded at the detector without the sectioning approach if all recordings of the three excitation patterns were added together. This signal could not be observed separately in the presence of the first decay. The illustration merely serves to show that the location-related decay behavior of the second decay extends partly in the focal plane and partly outside the focal plane.

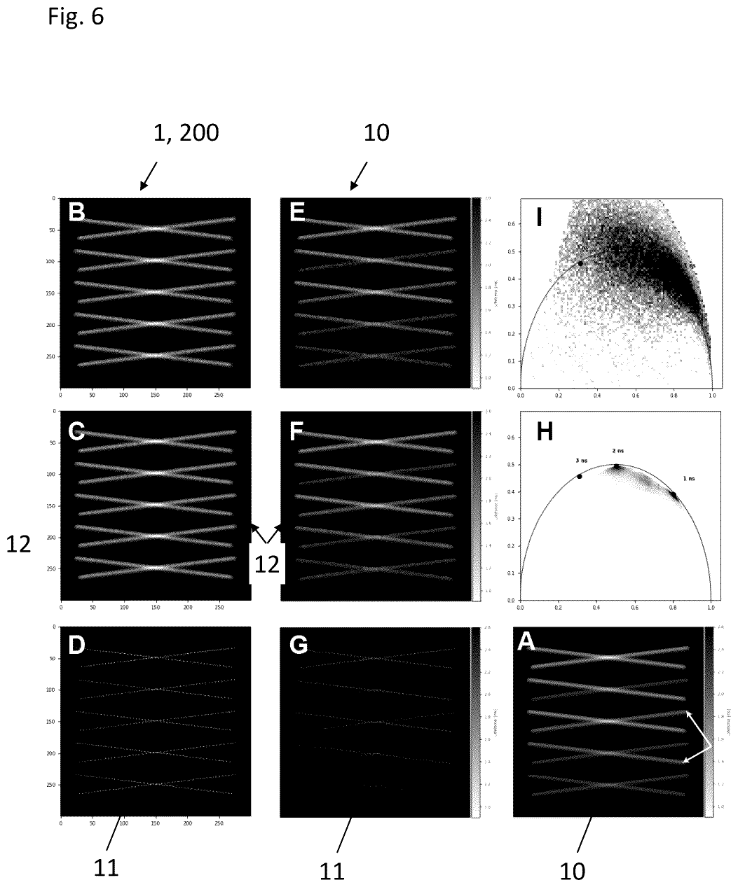

FIG. 6 represents an advantageous aspect of the invention. According to some variants of the invention, it is possible to reconstruct the location-related decay behavior with extremely low noise. As described in the previous paragraphs, this is done in particular by overfitting the model function and the data.

FIG. 6, panel A represents the result of a simulation of a location-related decay behavior 10 a sample distribution 1 in 2D for high count rate statistics. The decay behavior represented here is determined individually for each image pixel using the first statistical moment along the time dimension. In the following, a lifetime determined in this way is referred to as the average lifetime. The sample distribution 1 extends along 10 lines that cross each other in pairs. There are four lines that express a single-exponential lifetime of one nanosecond (light gray), two lines that express a mixture of a single-exponential lifetime of one nanosecond and a single-exponential lifetime of two nanoseconds (white arrows) and four lines that express a single-exponential lifetime of two nanoseconds (dark gray). A Gaussian spatial spread function with a sigma of two image pixels simulates the spread of an optical system.

FIG. 6, panel B represents the intensity projection of a simulated sample distribution with comparatively low count rate statistics. The average number of simulated photons per image pixel is 20 and the corresponding shot noise is taken into account in the simulation.

FIG. 6, panel D represents the intensity projection of the reconstructed location-related decay behavior 12 of the data 200 from FIG. 6, panel B. According to the invention, a larger number of location-related decay functions (here three decay functions) than contained in the data (here two decay functions) are reconstructed. The lack of a spatial regularization and a higher number of iteration steps of the fitting method leads to a reconstruction which is characteristic of inverse problems and which is heavily affected by artifacts (here the decay into points).

FIG. 6, panel C represents the result of processing the data according to the method according to the invention, namely as an intensity projection for the spatial reconvolution of the reconstructed location-related decay behavior 12 of the data from FIG. 6, panel B. The reconvolved reconstructed location-related decay behavior 12 is freed from most of the noise and artifacts are very strongly suppressed. The spatial resolution is not negatively influenced and is at the level of the initial data 200.

FIG. 6, panel E represents the average lifetime 10 of the simulated sample distribution 1 at very low count rate statistics (corresponding intensity projection is FIG. 6, panel A). The average lifetime is very noisy, in accordance with the low count statistics of the simulated data 200.

FIG. 6, panel I shows a phasor diagram of a simulated sample distribution at very low count rate statistics (corresponding intensity projection is FIG. 6, panel A and corresponding average lifetime is FIG. 6, panel E). The phasor histogram is very noisy, in accordance with the low count statistics of the simulated data.

FIG. 6, panel F represents the average lifetime for the spatial reconvolution of the reconstructed location-related decay behavior 12 of the data from FIG. 6, panel B (corresponding intensity projection is FIG. 6, panel C). The average lifetime is considerably denoised and also shows a spatial resolution at the level of the initial data.

FIG. 6, panel H shows a phasor diagram for the spatial reconvolution of the reconstructed location-related decay behavior of the data from FIG. 6, panel B (corresponding intensity projection is FIG. 6, panel C and corresponding average lifetime is FIG. 6, panel F). There are very clear clusters around the true values of the simulated data, i.e. at 1 ns, 2 ns and a cluster on the straight line between these two values. The phasor diagram gives a clear indication of the high quality of the reconstruction, which is difficult to see with the naked eye in the grayscale images of FIG. 6, panel E and FIG. 6, panel F.

FIG. 6, panel G represents the average lifetime of the reconstructed location-related decay behavior 11 of the data from FIG. 6, panel B (corresponding intensity projection is FIG. 6, panel D). The lack of a spatial regularization and a higher number of iteration steps of the fitting method leads to a reconstruction which is characteristic of inverse problems and which is heavily affected by artifacts (here the decay points).

The invention makes possible an improved reconstruction of a location-related decay behavior of a sample distribution, in particular in the field of microscopy and related methods.

### EXAMPLES

### Example 1: Single Exponential Fit for Two-Dimensionally Captured Sample Distributions

In the following, an embodiment of the invention is outlined using the example of spatially two-dimensional measurement data with a further additional non-spatial dimension—in this example a temporal dimension in which information about the photon arrival times is contained, i.e. the data comprises a location-related temporal decay behavior of the sample distribution.

Such data can be regarded as a three-dimensional array, data(r, t). The spatially spreading effect is taken into account via a spatially two-dimensional PSF(r) and possible global models for a simple exponential decay result in (Further models could consider, for example, a response function of the detector (IRF as IRF(r)), or a signal background could also be spatially convolved):

$${model}_{1 exp , glob} ( params ( r ) , t ) = background ( r ) + PSF ( r ) {r}_{} ( A ( r ) \times {shift}_{t} ( {IRF}_{t} {t}_{} exp ( - t / τ ( r ) ) , {t}_{off} ( r ) ) ) \qquad Eq . 1.1$$

where model_{1exp,glob} refers to the model function, params(r) comprises the adjustable location-dependent terms, t is the time variable and r is the location variable, background(r) refers to a potentially location-varying background signal of the data. PSF(r) refers to the model of the spread function. \textcircled{*}ᵣ refers to the location-related convolution operator, \textcircled{*}ₜ refers to the time-related convolution operator, A(r) refers to an amplitude of the decay signal; IRFₜ is the response function of the detector and the recording system; τ(r) refers to the decay time associated with the decay behavior, and is an adjustable time-dependent term. shiftₜ ( . . . , t_{off}(r)) refers to a shift along a time variable by a time value t_{off}(r) that may depend on the location.

Another formulation of the model function can be as follows:

$${model}_{1 exp , glob} ( params ( r ) , t ) = background ( r ) + PSF ( r ) {r}_{} A ( r ) \times {shift}_{t} ( {IRF}_{t} {t}_{} exp ( - t / ( PSF ( r ) {r}_{} τ ( r ) ) ) , {t}_{off} ( r ) ) \qquad Eq . 1.2$$

In both cases, the spatial parameter distributions background(r),A(r), T(r), t_{off}(r) can be regarded as two-dimensional spatial parameter distributions, i.e. location-dependent terms. Which parameter distribution is subject to the spatially spreading effect of the PSF depends strongly on properties of the data-generating apparatus.

Equation Eq. 1.1 & 1.2 are examples of models that take such differences into account.

The loss function lossᵢₛ or else lossₚₒᵢₛₛₒₙ, also referred to as an error function in the context of the present specification, for the fitting of the terms can then be given, for example, by the following expression:

$${loss}_{ls} = Reg ( params ( r ) ) + {\sum }_{i , j , k} {( model ( params ( {r}_{i , j} ) , {t}_{k} ) - data ( {r}_{i , j} , {t}_{k} ) )}^{2} \qquad Eq . 2.1$$

Or alternatively

$${loss}_{poisson} = Reg ( params ( r ) ) + {{\sum }_{i , j , k}}^{model ( params ( {r}_{i , j} ) , {t}_{k} ) - data ( {r}_{i , j} , {t}_{k} ) \times log ( model ( params ( {r}_{i , j} ) , {t}_{k} ) )} \qquad Eq . 2.2$$

where Reg(params(r)) here represents a function of regularization terms that enforce a desired behavior, e.g. smoothness, of the reconstructed terms. In the context of the invention, either individual spatial parameter distributions can be regularized individually or the spatial dimensions of the entire model can be regularized, wherein the regularizations often take the form of differential operators. Common regularizations are e.g. Good's Roughness (GR) Reg_{GR}, Tikhonov Regularization (TR) Reg_{TR} and Total Variation (TV) Reg_{TV}, which can be parameterized for a spatial parameter distribution P(r) of the location-dependent terms as:

$${Reg}_{GR} ( P ( r ) ) = λ \times {\sum }_{i , j} \sqrt{P ( r )} Δ \sqrt{P ( r )} \qquad Eq . 3.1$$

$${Reg}_{TR} ( P ( r ) ) = λ \times {\sum }_{i , j} {\vert Γ P ( r ) \vert}^{2} with Γ = Δ , Γ = ∇ , Γ = 1 \qquad Eq . 3.2$$

$${Reg}_{TV} ( P ( r ) ) = λ \times {\sum }_{i , j} \vert ∇ P ( r ) \vert \qquad Eq . 3.3$$

In this case, λ is a weighting factor that determines a strength of the influence of the regularization and the differential operators refer to spatial gradients ∇ or spatial second derivatives Δ. These are typically approximated numerically using finite differences with very compact stencils.

Exemplary reconstruction results according to the invention for the spatial distribution τ_{recon}(r) of the decay time (i.e. of a location-related term) and a reconstructed intensity distribution I_{recon}(r)∝A_{recon}(r) are represented, for example, in FIG. 3.

### Example 2: Linear Unmixinq for Spatially Two-Dimensional Data

A further exemplary embodiment of the invention relates to the modeling of information via a linear combination of known patterns. In the case of lifetime data, these patterns can be given, for example, as reference decay functions, which are obtained from further measurements and/or evaluations of the existing data. Such reference decay functions can be parameterized both as single-exponential or multi-exponential decays, as well as taking more general forms. In this case, a global model with p reference decay functions can be written as:

$${model}_{pat , glob} ( params ( r ) , t ) = background ( r ) + {\sum }_{p} PSF ( r ) {r}_{} {I}_{p} ( r ) \times {Pat}_{p} ( t ) \qquad Eq . 4.1$$

wherein here the p reference decay functions Patₚ(t) themselves no longer depend on location-dependent terms to be reconstructed. The aim of parameter estimation for the patterns is therefore to reconstruct the weighting factors Iₚ(r) before the influence of the spread function.

A further application-relevant realization of the invention relates to a combined modeling of the data via reference decay functions and parameterized fit functions, e.g.:

$${model}_{comb , glob} ( params ( r ) , t ) = background ( r ) + {\sum }_{p} PSF ( r ) {r}_{} {I}_{p} ( r ) \times {Pat}_{p} ( t ) + PSF ( r ) {r}_{} A ( r ) \times {shift}_{t} ( {IRF}_{t} {t}_{} exp ( - t / ( PSF ( r ) {r}_{} τ ( r ) ) ) , {t}_{off} ( r ) ) \qquad Eq . 5.1$$

### Example 3: Linear Unmixinq for Spatially Two-Dimensional Multiview Data

In the following, the invention is outlined using the example of spatially two-dimensional measurement data with two additional non-spatial dimensions. One of these non-spatial dimensions is a temporal dimension, which contains information about the photon arrival time, i.e. the location-related decay behavior. In addition, there are d different data sets which contain further complementary information, i.e. the data can be regarded as a 4-dimensional array, data(r, t, d).

In one realization, these d different data sets can be collected via different spatial imagings, i.e. generated via d different spread functions.

In the field of confocal microscopy, this corresponds, for example, to data generated by image scanning microscopes with d detector pixels (each of which can be regarded as a point detector), see e.g. Castello, M., Tortarolo, G., Buttafava, M. et al. A robust and versatile platform for image scanning microscopy enabling super-resolution FLIM. Nat Methods 16, 175-178 (2019). https://doi.org/10.1038/s41592-018-0291-9

The information from these d detector pixels can be advantageously analyzed, e.g. the data can be split into a spatially low-spread portion, which originates from the focal plane, and a spatially higher-spread portion, which has its origin outside the focal plane. So far, however, this method is only known for data that does not contain any other non-spatial dimensions and cannot be easily transferred to the reconstruction of a location-related decay behavior. Furthermore, the known method uses a pixel-by-pixel evaluation and is therefore prone to errors if the SNR of the data is low.

In a reconstruction according to the invention, both disadvantages are avoided. This is described below by way of example for modeling with p reference decay functions and q reference distributions Pat_{q}(d) across the d detectors:

$${model}_{pat , ISM , glob} ( params ( r ) , t , d ) = background ( r ) + {\sum }_{p , q} PSF ( r ) {r}_{} {I}_{p , q} ( r ) \times {Pat}_{p} ( t ) \times {Pat}_{q} ( d ) \qquad Eq . 6.1$$

where the case of q=2 reference distribution Pat_{q}(d) is sufficient to achieve high-quality modeling of the information in the focal plane and outside the focal plane (see e.g. FIG. 4). The aim of a parameter estimation is therefore to reconstruct the weighting factors I_{p,q}(r) before the influence of the spread function, i.e. for each of the p reference cases the portion of that information which originates from the focal plane and that proportion of information which is attributable to areas outside the focal plane. For the latter, modeling with effective spread functions is sufficient, wherein at least some can take the form of a delta distribution.

### Example 4: Linear Unmixinq for Spatially Two-Dimensional Multiview Data Via a Three-Dimensional Deconvolution

In the following, the invention is outlined using the example of spatially two-dimensional measurement data with two additional non-spatial dimensions. One of these non-spatial dimensions is a temporal dimension, which contains information about the photon arrival time. In addition, there are d different data sets which contain further complementary information, i.e. the data can be regarded as a 4-dimensional array, data(r, t, d).

In one embodiment, these d different data sets can be collected via different spatial imagings, i.e. generated via d differently spreading PSFs. In the field of confocal microscopy, this corresponds, for example, to data sets that were collected with d different pinhole sizes. However, the method from example 3 cannot be applied directly in such a case and a solution is only shown in the prior art for data without any further non-spatial dimension. In the latter, too, only pixel-by-pixel evaluations are used, which results in increased susceptibility to errors at low SNR.

In a more general approach, the spatially two-dimensional data is modeled according to its spatially three-dimensional image formation. If d different data sets are available that contain complementary information regarding the third spatial dimension, such modeling can be used to calculate advantageous reconstructions. Such modeling can be transferred to a variety of imaging systems, e.g. also to camera-based systems that use structured illumination. However, this more general approach is also only shown for intensity-type data without further non-spatial dimensions, in particular without a location-related decay behavior.

A further realization of the reconstruction according to the invention extends this approach to data sets containing information in further non-spatial dimensions, e.g. TCSCP data.

This is described below by way of example for modeling with p reference decay functions and q illumination patterns Illu_{q}(r, z, d):

$${model}_{pat , sect 2 d , glob} ( params ( r , z ) , t , d ) = background ( r , z ) + {\sum }_{p , q} PSF ( r , z ) {r , z}_{} ( Illu \vert q ( r , z , d ) \times I \vert p ( r , z ) ) \times {Pat}_{p} ( t ) \qquad Eq . 7.1$$

For the actual parameter optimization, the spatially two-dimensional data is expanded to three spatial dimensions (embedding in 3D). This means that the original data is regarded as a plane along the extended third spatial dimension, e.g. as the central plane z_{c}, while all elements outside this plane z_{c} are zero. The loss function for the parameter estimation is now only evaluated in the plane z_{c}. Such an optimization receives information that originates from the focal plane in the plane z_{c} and propagates that portion of information which originates from planes outside the focal plane to other planes along the third spatial dimension (see FIG. 6).

### Example 5: Denoising Via Reconvolution

In the following, a further advantageous realization of the invention is outlined using the example of spatially two-dimensional measurement data with a further additional non-spatial dimension—in this example a temporal dimension in which information about the photon arrival time (i.e. the decay behavior) is contained. The decay behavior can also be encoded in the data using a frequency domain measurement instead of a TCSPC measurement. It is also possible to collect the data from a so-called time-gated FLIM measurement. This is irrelevant for this and the previous examples.

The data can be regarded as a three-dimensional array data(r, t). The spatially spreading effect is taken into account via a spatially two-dimensional PSF(r). Along the time dimension, the data is modeled using a linear combination of k decay functions.

$${model}_{reconv} ( params ( r ) , t ) = background ( r ) + PSF ( r ) {r}_{} {\sum }_{k} ( {A}_{k} ( r ) \times {shift}_{t} ( {IRF}_{t} {t}_{} exp ( - t / ( PSF ( r ) {r}_{} {τ}_{k} ( r ) ) ) , {t}_{off} ( r ) ) ) \qquad Eq . 8.1$$

The sample distribution can be regarded via the terms background(r),Aₖ(r),τₖ(r), t_{off}(r) as 2×k+2 two-dimensional spatial parameter distributions, while \textcircled{*}ᵣ and \textcircled{*}t refer to a spatial and temporal convolution, respectively.

The peculiarity of this advantageous realization of the invention relates to the fact that the aim is not to generate a reconstruction of the sample distribution that has a higher spatial resolution, but that the fitted location- and time-dependent terms are convolved again with the model of the spread function after the fitting of the model function (“reconvolution”). In this way, a reconstructed sample distribution and, in particular, also a reconstructed location-related decay behavior is generated with the adjusted and reconvolved terms A_{reconv,k}(r), τ_{reconv,k}(r), which has the same spatial resolution as the original data, but has a lower SNR compared to the non-reconstructed sample distribution and is therefore, in particular, highly denoised. This applies both to the spatial dimensions of the reconstructed sample distribution, since the model of the spread function has no noise, and to the temporal dimensions of the sample distribution, since the location-related decay behavior can be represented as a superposition of the plurality k of decay functions. In particular, in the actual optimization step, i.e. the fitting of the model function to the data, any regularization of the error function with regularization terms can be dispensed with, such that the terms Aₖ(r),τₖ(r) can largely be regarded as overfitting artifacts.

The elimination of regularization is an additional advantage, as it also eliminates the need to enter the regularization weights of the regularization terms manually or partially automatically using heuristics. Furthermore, this realization shows a high stability even with low count statistics, i.e. very noisy data.

The k decay function can be adapted to the context of the information contained in the data, e.g. k=2 decay functions can be used if the data has mono- or bi-exponential decays in good approximation. This variant corresponds to a denoising “fitting” of the data.

In a further variant, a set of decay functions which comprises more decay functions than are contained in the sample distribution or can be meaningfully reconstructed on the basis of finite counting statistics is used, i.e. for most applications with finite count statistics, this set comprises k≥4 decay functions.

The terms of the decay constants τₖ(r) or else τ_{reconv,k}(r) can be additionally restricted in the fitting so that their value ranges do not overlap, or even a set of k≥4 reference decay functions, each with static τₖ, can be used. This variant corresponds to a denoising effective modeling of the data, which leads to very good results in evaluation steps that only use an average or effective average lifetime.

For these scenarios, it is also a highly effective way of compressing data or else information.

In a further variant of the realization, different data sets, e.g. at least two data sets at a certain axial/focal distance, or multiview data (see examples above) can be taken into account in the modeling. This variant is highly relevant to applications in microscopy, for example, as it enables, simultaneously, both denoising modeling of the data and computational unmixing (computational sectioning) into portions of information that originate from the focal plane and those that originate outside the focal plane.

### LIST OF REFERENCE SIGNS

1 Sample distribution
10 Location-related decay behavior
11 Reconstructed location-related decay behavior
12 Noise-reduced reconstructed location-related decay behavior
100 Model function
200 Data
201 IRF
300 Result
400 Histogrammed representation of the location-related decay behavior
501 Excitation pattern
x,y Spatial dimensions

1. A method, in particular a computer-implemented method, for reconstructing a location-related decay behavior (10) of a sample distribution (1) extending along one or more spatial dimensions (x,y), wherein the method comprises the following steps:
providing data (200) of the sample distribution that has information about a location-related decay behavior (10) of the sample distribution and information about the spatial dimension(s),
fitting a model function (100) to the data (200) to reconstruct the location-related decay behavior (10) of the sample distribution (1), wherein the model function (100) comprises adjustable location-dependent and time-dependent terms and at least one convolution with at least one of the location-dependent terms and a model of at least one spatial spread function, wherein the location-dependent and time-dependent terms are configured to model the location-related decay behavior (10) of the sample distribution (1), in particular so that the location-related decay behavior (10) is reconstructed in the course of the fitting,
outputting a result (300) of the fitting of the model function (100) to the data, wherein the result (300) comprises information about the location-related decay behavior (11) of the sample distribution (1) reconstructed by the fitting.

2. The method according to claim 1, wherein the model function (100) comprises one or more mixed terms that are both time-dependent and location-dependent.

3. The method according to claim 2, wherein at least one mixed term is convolved with the model of the at least one spatial spread function.

4. The method according to claim 1, wherein, when fitting the model function (100), the terms are fitted such that an error function indicative of a noise statistic of the data is minimized.

5. The method according to claim 4, wherein the error function contains one or more regularization term(s).

6. The method according to claim 1, wherein the reconstructed location-related decay behavior (11) of the sample distribution (1) is convolved with the fitted model of the at least one spatial spread function, so that a noise-reduced reconstruction of the location-related decay behavior (12) of the sample distribution (1) is generated, in particular wherein this noise-reduced reconstruction (12) is output at least as part of the result.

7. The method according to claim 1, wherein the data (200) comprises information about a further property of the sample distribution (1), in particular information about a location-related fluorescence spectrum of the sample distribution (1), wherein the model function (100) comprises further adjustable terms which model this property.

8. The method according to claim 1, wherein the data (200) of the sample distribution (1) containing information about the location-related decay behavior (10) and/or further properties of the sample distribution (1) are compressed with respect to the location-related decay behavior (10), in particular wherein the data relating to the location-related decay behavior (10) has a histogrammed representation (400) of the location-related decay behavior (10), which has non-equidistant bins in each case, in particular wherein a width of the bins is implemented as a function of an information content of the histogrammed representation (400), in particular wherein, the lower an associated histogram value is, the greater the width of the bins.

9. The method according to claim 1, wherein the model function (100) comprises a plurality of predefined patterns, wherein each pattern is associated with a term from the model function or is comprised by a term which is configured to cause a weighting, in particular a location-dependent weighting, of the pattern in the model function (100).

10. The method according to claim 9, wherein each pattern of the plurality of patterns is selected from the group consisting of:
a decay behavior;
a spatial spread function;
a spectrum, time-resolved or steady-state;
an out-of-focus signal;
an in-focus signal; or
a combination of the above group elements.

11. The method according to claim 1, wherein two or more recordings of the sample distribution (1) are provided, wherein the model comprises two or more different spread functions, wherein the model comprises, for each of the two or more spread functions, at least one in-focus and one out-of-focus distribution of the spread function in each case, wherein a focus signal of the sample distribution is modeled on the basis of the in-focus and out-of-focus distributions and a signal of the sample distribution which lies outside a focal plane is modeled, and, by means of the fitting of the model function (100), a representation of the sample distribution which lies in focus is generated.

12. The method according to claim 11, wherein one spread function of the two or more spread functions comprises an excitation pattern (501), and another spread function of the two or more spread functions comprises a detection spread function.

13. An optical imaging system, in particular an optical microscope system, having a microscope and a computer which is configured to control the microscope system and to receive the data recorded by the microscope and process it according to the method according to claim 1.

14. A computer program comprising computer program code which, when executed on a computer, performs the method according to claim 1.
